(19) United States
(12) Patent Application Publication
(10) Pub. No.: US 2021/0058844 A1
(43) Pub. Date: Feb. 25, 2021

(54) Handoff Between Bot and Human

(71) Applicant: Microsoft Technology Licensing, LLC, Redmond, WA (US)

(72) Inventors: Raymond Robert Ringhiser, Maple Valley, WA (US); Gabriele Masili, Mercer Island, WA (US)

(73) Assignee: Microsoft Technology Licensing, LLC, Redmond, WA (US)

(21) Appl. No.: 16/544,677

(22) Filed: Aug. 19, 2019

(51) Int. Cl. H04W 36/36; H04W 36/10; H04W 36/00; H04W 36/16; G06F 17/27; G10L 15/22

(52) U.S. Cl. CPC H04W 36/365; H04W 36/10; H04W 36/00837; G10L 2015/227; G06F 17/279; G10L 15/22; H04W 36/16

(57) ABSTRACT

A method that enables handoff between a bot and human is described herein. The method includes monitoring a conversation between a user and a first bot to detect a trigger, wherein the trigger is detected by assessing one or more factors associated with the user, wherein assessing the one or more factors comprises a determination that a user frustration level exceeds a predetermined threshold. The method also includes, in response to a detected trigger, determining a type of a handoff to be executed, wherein the handoff is to a second bot or a human support agent and the type of handoff is based on an experience of the user. Additionally, the method includes executing the determined handoff to the second bot or a human support agent, wherein the second bot or a human support agent engages the user in conversation to execute functionality desired by the user.

### BACKGROUND

Generally, a bot is a software application that can execute automated tasks over a network, such as the Internet or a phone line. For example, a bot can be designed to conduct a conversation with a user via text, auditory, and/or visual methods to simulate human conversation. In particular, a bot may utilize natural language processing systems or scan for keywords from a user input, make one or more decisions with regard to the input and then generate a reply to the user input. Typically, bots are implemented in dialogue systems, natural language processing systems, and the like to perform various practical tasks, such as user support, and information acquisition.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In an embodiment described herein, a method that enables a handoff between a bot and a human is described. The method includes monitoring a conversation between a user and a first bot to detect a trigger, wherein the trigger is detected by assessing one or more factors associated with the user, wherein assessing the one or more factors comprises a determination that a user frustration level exceeds a predetermined threshold. The method also includes, in response to a detected trigger, determining a type of a handoff to be executed, wherein the handoff is to a second bot or a human support agent and the type of handoff is based on an experience of the user. Additionally, the method includes executing the determined handoff to the second bot or a human support agent, wherein the second bot or a human support agent engages the user in conversation to execute functionality desired by the user.

In another embodiment described herein, a system is described. The system comprises an intent monitor. The intent monitor is to monitor a conversation between a user and a first bot to detect a trigger, wherein the trigger is detected by assessing one or more factors associated with the user, wherein assessing the one or more factors comprises a determination that a user frustration level exceeds a predetermined threshold. In response to a detected trigger, the intent monitor is to determine a type of a handoff to be executed, wherein the handoff is to a second bot or a human support agent and the type of handoff is based on an experience of the user. Additionally, the intent monitor is to execute the determined handoff to the second bot or a human support agent, wherein the second bot or a human support agent engages the user in conversation to execute functionality desired by the user.

In another embodiment described herein, a method that enables a two-way handoff between a bot and a human is described. The method includes monitoring a conversation between a user and a bot to detect a trigger, wherein the trigger is detected by assessing one or more factors associated with the user, wherein assessing the one or more factors comprises a determination that a user frustration level exceeds a predetermined threshold. The method also includes, in response to a detected trigger, determining a type of a first handoff to be executed, wherein the first handoff is to a human support agent and the type of handoff is based on an experience of the user. Additionally, the method includes executing the determined first handoff from the bot to the human support agent, wherein the human support agent engages the user in conversation to execute functionality desired by the user. Further, the method includes monitoring a conversation between the user and the human support agent to detect a signal, wherein the signal is an indication that the functionality desired by the user is complete. The method also includes, in response to the detected signal, executing a second handoff from the human support agent to the bot.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an exemplary network environment suitable for implementing aspects of the disclosed subject matter, particularly in regard to a handoff between a bot and human as described herein;

FIG. 2 is an illustration of a decision tree;

FIG. 3 is an assessment matrix that enables an intent monitor to predict or identify a level of user frustration;

FIG. 4 is an illustration of a communication flow;

FIG. 5 is an illustration of a process flow diagram of a method that enables a handoff between bot and human;

FIG. 6 is an illustration of a process flow diagram of a method that enables two-way handoff between a bot and human;

FIG. 7 is a block diagram illustrating an exemplary computer readable medium encoded with instructions to enable a handoff between bot and human according to aspects of the disclosed subject matter; and

FIG. 8 is a block diagram illustrating an exemplary computing device configured to enable a handoff between a bot and human according to aspects of the disclosed subject matter.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

Generally, bots are software applications that run automated tasks over a network, such as the Internet or a phone line. Bots are designed to conduct a conversation with a user via auditory or visual methods to simulate human conversation. A bot may utilize natural language processing systems or scan for keywords from a user input to generate a response to the user input. Often, bots are often utilized in tasks such as user service or information acquisition. An organization may also use human support agents to engage in tasks such as service, information acquisition, or other support. However, bots typically operate without human support agent engagement. As described herein, a support operator is a bot or human support agent that is assigned tasks with respect to a user.

As an example, one or more bots may be deployed in a technical support scenario. Each bot may be customized according to a particular technical support need. A user may engage a bot in conversation to obtain a solution to a technical problem. Consider a user that owns a device for use with a computing system. In the event that the device fails to be recognized or communicate with the system, the installation of a device driver would likely solve the issue. When the user contacts the organization for support, a bot can diagnose the issue, determine a solution to the issue, and if needed, complete any remaining tasks to resolve the issue. In this example, a bot may ask a series of questions to diagnose the user issue. The bot may also be able to automatically determine a solution to the issue by scanning the user's computer system. Finally, the bot may automatically install a device driver to resolve the user's issue. In this manner, a bot can efficiently and quickly resolve the user's issue.

However, circumstances may arise where a bot cannot satisfy a user request or another bot or human support agent is better suited to address the user request. The present techniques describe a handoff between a bot and human. According to the present techniques, the handoff may be seamless or transparent to a user. For example, the user may be unaware a handoff has occurred. In other examples, the user may be presented with an option to approve a handoff. In operation, the bot can respond to user input based on a conversational context of the input. In response to a trigger, the current bot can automatically connect the user with the second bot or a human support agent. The trigger may be, for example, based on the current bot recognizing that a second bot or human support agent would better address the user's needs when compared to the first bot. The trigger may also be based on a frustration level of the user. In response to the trigger, the second bot or human support agent may then engage in conversation with the user. When appropriate, the first bot can automatically reengage the user, without any directive to reengage the user from the human support agent. Further, the first bot may use feedback to train and update the learning models to improve the bot's responses over time based on each user. By contrast, typical bots fail to implement any adaptive intelligence when issues are encountered, thereby resulting in a negative user experience.

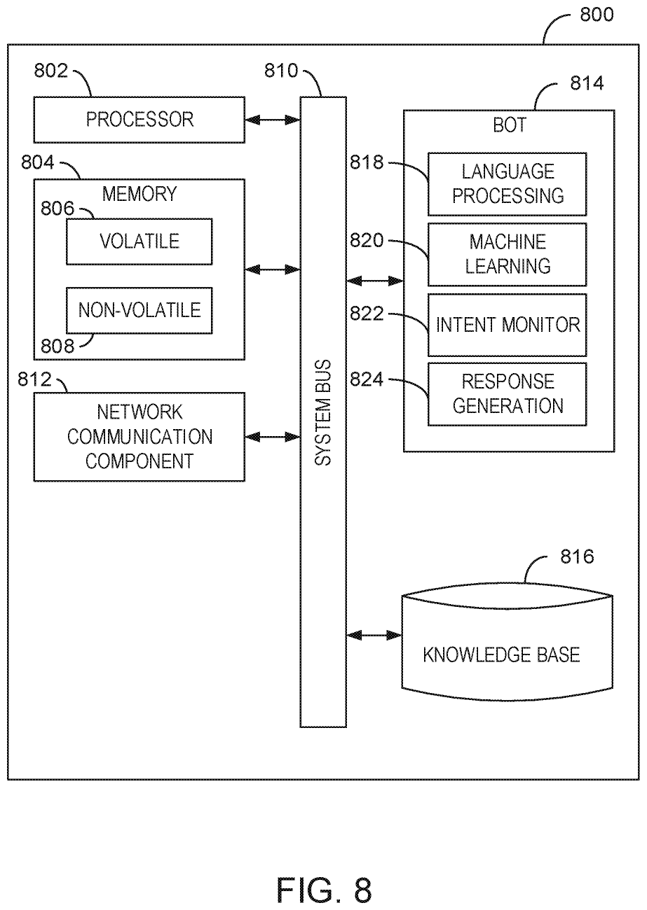

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 8 discussed below provides details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like. The communication media may include cables, such as fiber optic cables, coaxial cables, twisted-pair cables, and the like. Moreover, transmission media for wireless signals may include hardware that enables the transmission of wireless signals such as broadcast radio waves, cellular radio waves, microwaves, and infrared signals. In some cases, the transmission media for wireless signals is a component of a physical layer of a networking stack of an electronic device.

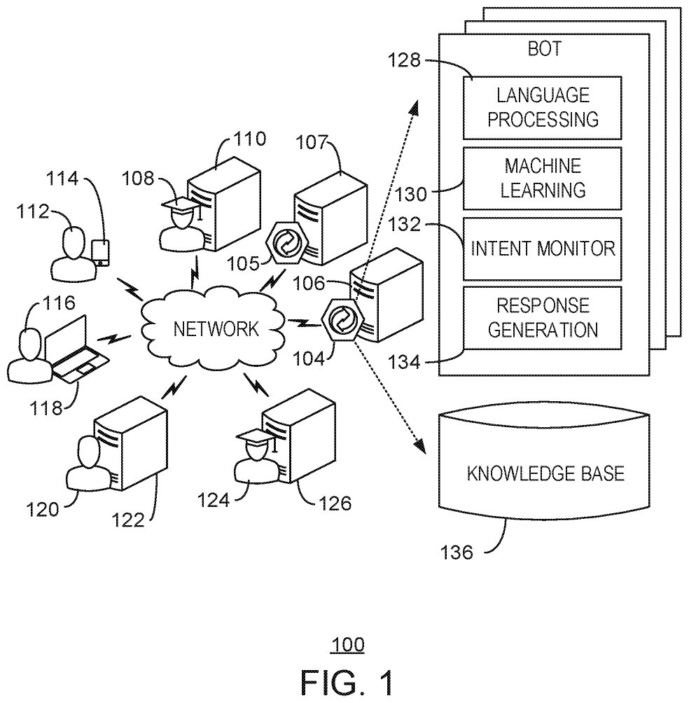

FIG. 1 is a block diagram of an exemplary network environment 100 suitable for implementing aspects of the disclosed subject matter, particularly in regard to a handoff between a bot and human as described herein. The network environment 100 includes a bot 104 that executes via an electronic device 106, and a bot 105 that executes via an electronic device 107. The network environment 100 also includes a human support agent 108 that accesses the network via a computing device 110. Similarly, a human support agent 124 accesses the network via a computing device 126.

As illustrated in FIG. 1, several users may also access the network. In particular, a user 112 may access the network via a cellular device 114. A user 116 may access the network via a laptop 118. Finally, a user 120 may access the network via an electronic device 122. Each of the user devices 114, 118, and 122 can execute a dialogue client. The dialog client enables capture of text, auditory, and/or visual input from a user. The user input is transmitted to the bot 104 or the bot 105 across the network.

In the example of FIG. 1, a number of devices are illustrated as providing access to the network. However, any electronic device may provide to access the network. As described herein, electronic devices include, but are not limited to, mobile phone devices, smart phone devices, tablet computing devices, laptop computers, desktop computers, servers, smartwatches, and the like. Each of the electronic devices may be configured with audio capture components (e.g., a microphone and supporting structure to capture/record audio content), and network communication components (such as a network interface device).

A bot 104 or bot 105 may include hardware, software, or any combination thereof, to engage a user in conversation across the network. In particular, the bot may receive user input and generate a response based on the input. One or more bots may be available in the network environment 100. Each bot may support various functionality within an organization. Bot functionality may be, for example providing information on products and services that the user intends to acquire or use, or answering “how-to” questions that the user may have on a specific functionality of an acquired product or service. Bot functionality may also include diagnosing problems occurring with the user's products or services, and taking corrective action to resolve those problems.

In the example of FIG. 1, each bot may include processing elements that enable the various bot functionality. For example, the bot 104 includes a language processing module 128, a machine learning module 130, an intent monitor 132, and a response generation module 134. Additionally, the bot includes a knowledge base 136 stored on the electronic device 106. At the language processing module 128, input from a user is processed to derive a request, query, or other information from the user input. The user input may represent a request from the user for a particular task or some desired functionality. The user input may also represent a request for information or assistance. In some cases, the user input is information or a description of a problem. The language processing module may implement natural language processing to interpret the human language contained in the user input. In embodiments, the natural language processing may be used by the machine learning module to extract entities and intents from the user input.

At the machine learning module 130, observations may be made in response to the user input. In particular, the machine learning module 130 enables the bot to learn from the entities and intents extracted from the user input via natural language processing. As used herein, an intent is an intention of a user. An entity is a descriptive aspect of the intent. In some cases, the machine learning algorithms according to the present techniques may be based on a classification algorithm that includes decision tree. The decision tree may include a series of observations that are used to arrive at a conclusion. Various entities and intents may be mapped to elements of the decision tree. The bot may access a knowledge base 136 as needed. Elements of the decision tree may be used by the response generation module 134 to determine a pre-written response to the original user input. The response generation module may transmit the pre-written response to a dialogue client where it is rendered for the user in a text, auditory, or visual format.

The intent monitor 132 may identify an intent of the language used by the user during engagement with the bot. The intent monitor 132 may monitor turns of conversation between a customer and a bot via the bot's logic. During the turns of conversation, the intent monitor assesses the conversation between the user and the bot to determine if a second bot or a human support agent is better suited to engage with the user when compared to the currently selected bot. In embodiments, the intent monitor may predict that the user will subsequently encounter a point at which the bot can no longer be of assistance. The prediction may be derived from one or more factors that are assessed by the intent monitor. In an embodiment, each factor contributes to a user frustration level. If the user frustration level exceeds a predetermined value, a handoff of the from the bot to a second bot or human support agent may occur. The handoff may be temporary, partial, of full as described below.

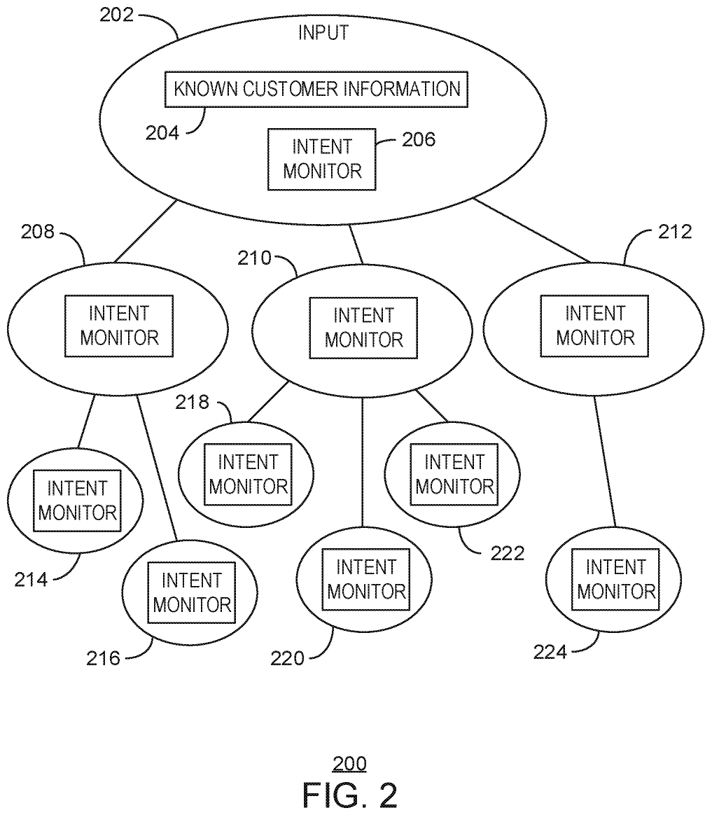

FIG. 2 is an illustration of a decision tree 200. Machine learning according to the present techniques may incorporate multiple attributes into a model and predict when a handoff in a conversation should occur. The multiple attributes include, but are not limited to the user's tone, the choice of words used (e.g. derogatory), the pace of user's answers, and the like. Further, the machine learning algorithm may learn when a bot is triggered to handoff to a second bot or human support agent. The bot as described herein may map user input to intents and entities as modeled by the decision tree. The decision tree 200 may cause the generation of one or more pre-written responses depending on user input. In embodiments, the responses may be obtained via a node of the decision tree.

For example, at the root node 202, a user input is obtained. The branches from the root node 202 each correspond to an observation in response to the user input at root node 202. In embodiments, the particular branch or outcome selected may be in response to input from the user. The branches lead to internal node 208, node 210, and node 212, respectively. Each internal node corresponds to an outcome of the observations of the user input at the root node 202. The branches from each internal node 208, 210, and 212 correspond to a further observation from their respective internal node. Each node may continue to split into one or more nodes based on further observations until a leaf node is reached. As illustrated, node 214, node 216, node 218, node 220, node 222 and, node 224 represent leaf nodes of the decision tree 200. In embodiments, a leaf node represents a final outcome based on series of user inputs in response to the bot response generation. In this manner, user responses may guide a traversal of the decision tree based on a scripted series of dialogue from the bot. For ease of description, a limited number of nodes are illustrated in the decision tree 200. However, a decision tree according to the present techniques may be of any size and include any number of nodes. In embodiments, the decision tree may grow as the bot learns additional information, conditions, and resources that can be integrated into the decision tree 200. For ease of description, the machine learning as described herein is illustrated using the decision tree as a classification model. However, any number of classification models may be used in the machine learning according to the present techniques. For example, a decision graph may be implemented according to the present techniques. In the decision graph, there is no single direction to traverse the graph, and the nodes may be linked many-to-many. Other models used according to the present techniques may be random decision forests, decision jungles, and the like.

At each node in the example of FIG. 2, an intent monitor assesses the input from a user that resulted in a progression to the node within the bot logic. In particular, the input from the user to the bot is analyzed to determine if another second bot or human support agent is better suited to resolve issues as determined in the user input. For example, consider a scenario where the current bot is an information bot that provides generally information on products and services a user has acquired or desires to acquire. The information bot may determine that an issue expressed by the user is a technical issue that can be solved by a technical support bot. In this scenario, the intent monitor may cause a handoff of the conversation from the information bot to the technical support bot. In embodiments, when the intent monitor detects a point at which the bot can no longer be of assistance to the user, the system may pass the conversation to a second bot or human support agent better equipped to resolve the user's issues. In this example, the recognition that a second bot or human support agent is better equipped to solve the user's issues is a trigger that causes a handoff from the current bot to the second bot or human support agent. As used herein, passing the conversation to the second bot or human support agent may include transmitting the subject of the bot conversation, the user's language, and a current date and time to a human support agent. In some cases, a bot may transparently pass the conversation to a human support agent by indicating to the user that the conversation is being transferred to a human support agent. The bot may also issue a query to the user to determine if a transfer to a human support agent is desired. In this manner, intent monitor may continually monitor turns of conversation via the bot logic.

The execution of a handoff of control of a conversation may be based on one or more factors that are analyzed to predict user frustration or limitations. In embodiments, the one or more factors may trigger a handoff of control of the conversation. A trigger, as used herein, may describe a point in time where the bot cannot be of assistance to the user. Additionally, a trigger may be when the current bot recognizes that a second bot or human support agent has a higher likelihood of satisfying a user need when compared to the current bot. The trigger may be detected by assessing one or more factors associated with the user, wherein assessing the one or more factors includes a determination that a user frustration level exceeds a predetermined threshold.

User frustration may indicate a negative emotional status of a user. User limitations may indicate a particular constraint on abilities of the user. In embodiments, user frustration may be caused by the particular limitations of a user. Generally, a trigger may be detected when a predicted user frustration level or user limitation is exceeded. The prediction may be based on any number of factors, including but not limited to a semantic analysis of the textual content, structural and grammatic analysis of the textual content, command/verb dictionaries, text format, trigger words/phrases, a user intent, user attributes, and any combinations thereof. The prediction may also be based on historic data of user frustrations or limitations associated with the current user that caused a handoff. In embodiments, the prediction may also be based on aggregated historic data of user's with known information similar to that of the current user. Finally, in embodiments, the prediction may be based on general historic data for all users. In this manner, the present techniques enable a handoff scheme that is operable across all operating systems, browsers, and the like. As a result of machine leaning, the bot may become more efficient over time and can expand its knowledge of factors and how they impact the determination of a trigger.

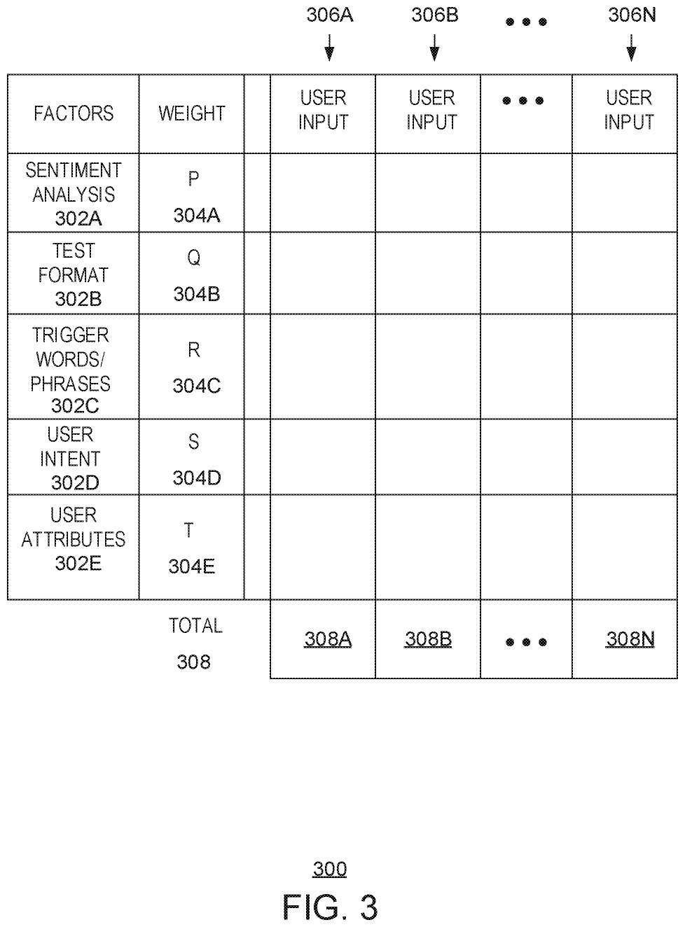

FIG. 3 is an assessment matrix 300 that enables an intent sensor to predict or identify a level of user frustration. The assessment matrix is used to assess various factors associated with the user. In response to an assessment of the factors that triggers a handoff, a type of handoff may be determined and the handoff is performed to enable control of the conversation by another second bot or human support agent. In particular, another second bot or human support agent enables a practical application in support of user needs identified in the conversation. The handoff as described herein may be exactly tailored to a particular purpose of the user.

As illustrated in FIG. 3, the assessment matrix lists a plurality of factors 302. In particular, the factors include a sentiment analysis 302A, a text format 302B, trigger words or phrases 302C, user intent 302D, and user attributes 302E. Although particular factors are illustrated, any type of factors may be used according to the present techniques. The assessment matrix 300 also includes a plurality of score values 304. In particular the plurality of score values 304 includes a score P 304A, a score Q 304B, a score R 304C, a score S 304D, and a score T 304E. As illustrated in FIG. 3, each score value is represented by a variable. Each possible score value may have a maximum value for each factor. The score values for each user input may be selected such that an importance of each factor in triggering a handoff is directly proportional to the score value for that factor. For example, the user attributes factor 302E may have a higher importance with regard to a predicting a user level of frustration when compared with a text format factor 302B. Thus, the score T 304E applied to the user attribute factor 302E may be larger than the score Q 304B applied to the text format factor 302B.

Each user input 306 is evaluated in view of each of the plurality of factors 302. In embodiments, the user inputs 306A, 306B, . . . , 306N, are evaluated to determine if a particular factor is detected in the input. For example, a user input 306A may be evaluated for the particular sentiment found in the input. If a negative sentiment is determined, the user input 306 a may be attributed with a full score with respect to sentiment analysis. For each factor, the user input can be scored based on the presence of the particular factor in the user input. The scores with respect to each user input may be summed to calculate a total score for each input. Thus, in FIG. 3 a total score 308 is illustrated for each input. In particular, a score 308A may be calculated for an input 306A, a score 308B may be calculated for a user input 306B, and so on. A predetermined threshold may be applied to the total score 308 for each user input. In the event that the total score for a user input exceeds the predetermined threshold, a trigger may be detected. Accordingly, as used herein a trigger may be detected via one or more factors, alone or in combination, that indicate a user frustration level is has exceeded a pre-determined level.

As illustrated in FIG. 3, an exemplary factor that may indicate user frustration or limitations is a result of sentiment analysis. In sentiment analysis, an attitude or emotional tone of the user is determined based on the text derived from the user input or responses. In embodiments, a negative affectivity detected in the language of the user during conversation may indicate a high level of user frustration. By contrast, a positive affectivity detected in the language of the user during conversation may indicate a low level of user frustration. In embodiments, an intent monitor may analyze input from the user by analyzing sentiments of the input. When a negative sentiment analysis is detected, a high level of user frustration may result triggering a handoff from bot engagement with the user in conversation to another second bot or human support agent.

Another factor that may indicate user frustration or limitations is a text format of the user input. When the user input is in text form, a text format is the particular symbols selected by the user to convey information. For example, a text format of the user input may be writing in all capitalized letters. Writing in all capitalized letters may indicate “yelling” or other displeasure from the user. In such a scenario, a user may be experiencing a high level of frustration and conveys the frustration through the text format. In some cases, a user may write using digits as substitutes for letters. For example, a user may input “I h@ve an i$$ue with my device.” The grammatically correct input would be “I have an issue with my device.” In this scenario, the text format selected by the user may indicate that a human support agent would be better suited to interpret the user's use of alternative symbols.

In another example, consider a scenario where a user is asked to verify a license product key that consists of five sets of five digits. For example, the user may continually respond with “the license is 834-92374-65297-84163.” However, such a product key may be unintelligible to the bot, which expects five sets of five digits. In an example, if this is the only factor that indicates a human is needed, the bot may generate a response that seeks a full set of five sets of five digits. However, if other factors indicate that a user limitation is met or exceeded and the user does not understand how to obtain the full product key, a human support agent may engage the user to resolve the determination of the product key.

Particular trigger words or phrases that suggest failure of the bot to engage the user successfully may also be another factor that may indicate user frustration or limitations. A failure to engage the user is an inability of the bot to obtain intelligible input from the user in response to bot-generated responses. Certain words or phrases may be designated as trigger words, where one or more occurrences of the trigger words is a factor in user frustrations or limitations. For example, expletives may be considered trigger words. Additionally, derogatory words and phrases may also be considered in determining user frustration or limitations. In embodiments, the use of a trigger word or phrase may automatically trigger a handoff to a human support agent.

User intent is a determination of what the user desired in view of the actual user input and can be a factor in determining a user frustration level. When the user input is a typed statement, the user intent is extracted from the text as an actual purpose of the user in engaging in a conversation with the bot. The user intent may be derived by classifying terms of the query based on natural language processing. For example, in response to a bot prompting, “How can I help you?”, a user may input “won't load, non-functional, cannot use device.” Here, an exemplary user intent may be the correction of a software issue associated with device driver installation. However, this is not immediately evident from the user intent. Once derived, the intent monitor may determine that a particular user intent may be best addressed by a human support agent or another bot. Additionally, user attributes may be factors that indicate user frustration or limitations and can predict handoff. User attributes as described herein may be a part of historic data, gathered over time. In embodiments, the user attributes include, but are not limited to, a native language, geolocation, time zone, prior communications, or any combination thereof. Additional factors may include a number of turns in the conversation, particular terminology used in the conversation (such as terminology that indicates fraud or illegal activity), and technical signals (such as a Bluetooth radio being turned off).

The one or more factors as discussed above may be assessed by the intent monitor to detect a trigger of a handoff from a bot to another bot or human support agent. In particular, each factor may be evaluated for the level of user frustration or user limitation it represents. The factors may be evaluated alone or in combination with other factors to determine a level of user frustration or limitation. When a trigger is detected, each factor may also be analyzed to determine a type of handoff.

The assessment matrix 300 is illustrated for exemplary purposes and should not be viewed as limiting. Various techniques may be used to evaluate one or more factors to determine a level of user frustration, either alone or in combination with other factors. Accordingly, factors as described herein may be evaluated according to different techniques. Moreover, each factor may be scored, weighted, ranked, or any other ordering applied to analyze an importance level of the factor on user frustration levels. The scoring as described is for exemplary purposes and should not be viewed as limiting on the technique used to determine an impact of a factor on the user frustration level.

By implementing intent monitors to analyze user input within a conversation, the bot can continually assess the factors in view of the input to determine the most appropriate support operator or user support professional upstream of a likely user end-point within a bot. When the intent monitor detects a back-and-forth progression of a user through the bot's logic that will likely subsequently encounter a point at which the bot can no longer be of assistance, the system passes the conversation to second bot or human support agent. In examples, the system may transparently pass along the subject of the bot dialog, the user's language, and a current date and time to a support agent selector. In embodiments, the support agent selector may use the received information to determine a particular bot or human support agent best suited to resolve the issue presented by the user.

If the user reaches a bot end-point, the user may be presented with a message like “I'm sorry I've not been able to resolve this issue. However, while we've been interacting I've contacted George in Las Colinas, Tex. who is the best qualified agent to assist you further. Would you like to me to connect you with George through phone or chat?” The user is then able to decide in real-time how the user wants to interact with the human support agent. When the user selects the desired contact method, he or she is either transferred to the now-waiting George in a chat window or the user is asked to enter his or her phone number where George might call immediately.

The handoff as described in the above example may be a partial handoff where the human support agent can supplement responses from the bot with human responses. In some embodiments, the human support agent may also change or modify input to bot. The handoff may also be a temporary handoff, where control of the conversation is passed from the first bot to the human support agent for a particular amount of time or until an issue is resolved. An event may occur that automatically reconnects the conversation with the bot. Accordingly, in examples the control of the conversation may be passed to a human support agent that generates responses to the user, the original bot may automatically reengage the conversation in response to a resolution of an issue. Furthermore, a handoff may transfer control of a conversation from a first bot to a second bot that may be better able to handle a user request.

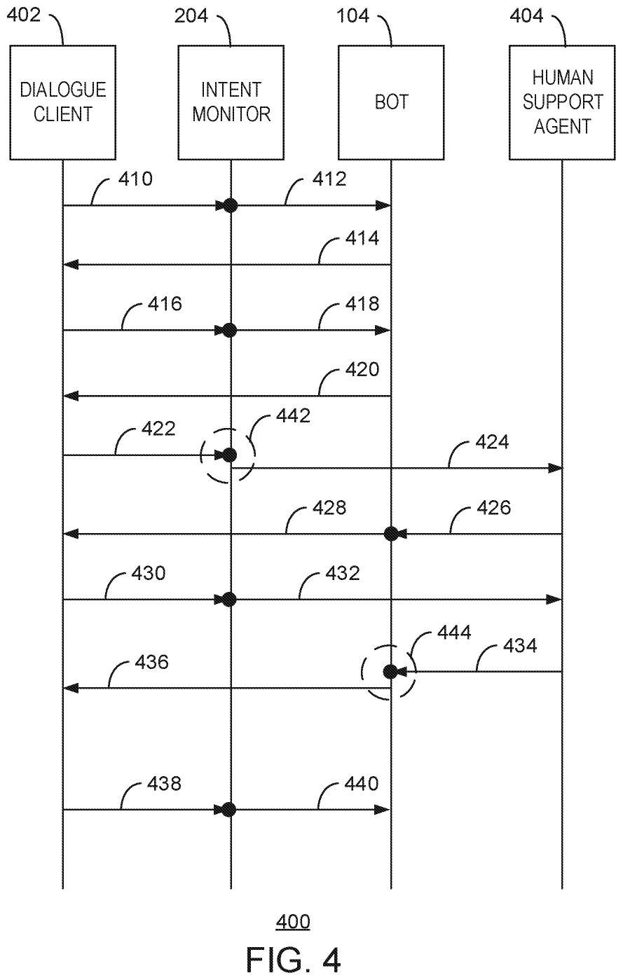

FIG. 4 is an illustration of a communication flow 400. In the example of FIG. 4, a dialogue client 402, an intent monitor 204, a bot 104, and a human support agent 404 are illustrated. In this example, the dialogue client 402 is a user facing application that may be used to capture user input at an electronic device. Referring to FIG. 1, a dialogue client may execute on the electronic device 114 and capture input from a user 112. A dialogue client may also execute on the electronic device 118 and capture input from a user 116. Moreover, a dialogue client may execute on the electronic device 122 and capture input from a user 120. The dialogue client may also render a generated response from a bot on a display of the electronic device. In this manner, a user may read the response as generated by the bot. In embodiments, the dialogue client may also render an audio response.

The intent monitor 204 may monitor user input as captured by the dialogue client 402. In particular, the intent monitor 204 may scan user input and continually monitor factors that are used to predict a level of user frustration or user limitation. In the event that a predicted level of user frustration or user limitation exceeds a threshold level, the intent monitor may hand off the conversation to a bot or human support agent, such as a human support agent or another bot. In response to handing off the conversation to a human support agent, the bot 104 may monitor the conversation between as input to the dialogue client 402 and transmitted to the human support agent 404. In some cases, the bot 104 may automatically reengage the user in conversation when an issue is resolved or some other event occurs.

Generally, communication flow from the dialogue client 402 represents input from a user at the dialogue client. Natural language processing may be applied to user input captured at the dialogue client 402. In the example of FIG. 4, at reference number 410 a user input is transmitted from the dialogue client 402 to the bot 104. The user input is intercepted or monitored by the intent monitor 204. At reference number 412, the intent monitor 204 forwards the user input to the bot 104. In this first exchange of user input, the intent monitor 204 does not detect a user frustration level or user limitation that triggers a handoff from bot engagement with the user to human support agent with the user. Accordingly, at reference number 414 the bot generates a response to the user input. The transmission of a user input to the bot 104 and a subsequent response generated by the bot and transmitted to the dialogue client represents a turn of conversation between the user and the bot.

Based on the generated response from the bot at reference number 414, the user may input additional information at the dialogue client 402. Again, at reference number 416, the user input is intercepted or monitored by the intent monitor 204. Thus, at reference number 418, the intent monitor 204 forwards the user input to the bot 104. For this second exchange of user input, the intent monitor does not detect a user frustration level or a user limitation that triggers a handoff from bot engagement with the user to a human support agent engagement with the user. Accordingly, at reference number 420 the bot generates a response to the user input which is transmitted to the dialogue client 402. The transmission of a response as indicated at reference number 420 completes a second turn of conversation between the user and the bot.

Based on the generated response at reference number 420, the user may input additional information at the dialogue client 402. At reference number 422, the user input is intercepted or monitored by the intent monitor 204. In response to the input at reference number 422, the intent monitor 204 detects a trigger such that the intent monitor 204 does not forward the user input to the bot 104. Instead, the intent monitor reroutes the user input to a human support agent 404. Thus, at reference number 424 user input is transmitted to a human support agent 404. In response to the user input at reference number 424, the human support agent 404 generates a response. Accordingly, at reference number 426 the human generated response is transmitted to the user. However, the bot 104 monitors each response generated by the human support agent 404. If the bot 104 detects an event indicating that the bot should reengage the user in conversation, a handoff may occur from the human support agent 404 to the bot 104. As illustrated in the example of FIG. 4, the bot does not detect any signal to reengage the user in conversation in response to the human support agent response at reference number 426. Thus, at reference number 428, the response generated by the human support agent 404 is transmitted to the dialogue client 402. This completes a third turn of conversation.

In embodiments, the detected signal may be an indication that some functionality desired by the user is complete. For example, a particular task or issue may cause a rise in the user frustration level and a first handoff from a first bot to a human support agent. When the particular task or issue is resolved, the first bot may reengage in conversation with the user. Note that the user input may have a plurality of tasks or issues. Particular tasks or issues may cause an increase in user frustration levels as indicated by one or more factors. The resolution of one or more tasks or issues, or the completion of a particular functionality as desired by the user, may cause a reduction in a user frustration level. In embodiments, when a second bot or human support agent has caused a reduction in a user frustration level, the first bot may reengage the conversation with the user. The signal may be generated by the intent monitor.

In response to the response generated by the human support agent 404, at reference number 430 the user provides additional input as captured by the dialogue client 402. The intent monitor may monitor conversation between the user and the human support agent 404. The intent monitor 204 may not initiate a handoff while the human support agent 404 is engaged in conversation with the user. However, the intent monitor 204 may still monitor the conversation between the user and the human support agent 404. During this exchange or turn of communication, the intent monitor may operate to capture data, feedback, known information of the user, or other attributes that may be used to grow or train a model that determines when handoffs occur.

At reference number 432, the user input is transmitted to the human support agent 404. In response to the user input at reference number 432, the human support agent generates a response that is transmitted as illustrated at reference number 434. In response to the human support agent generated response at reference number 434, the bot 104 may detect an event or signal from the human support agent 404 that indicates the bot should reengage the conversation with the user. In embodiments, the bot may also reengage the conversation with the user when the bot determines that an issue that caused the human support agent to engage in the conversation with the user is resolved. Accordingly, in response to a signal, event, or other indicator, the bot 104 reengages the user in conversation. Accordingly, at reference number 436 the bot generates a response to the user input obtained at reference number 430. The conversation between the user and the bot 104 continues with a new turn of conversation at reference numbers 438 and 440. The intent monitor 204 monitors the input, and in response to no triggers detected in the user input, forwards the user input to the bot 104 at reference number 440.

As illustrated in FIG. 4, in the event that the user frustration exceeds a pre-defined level the intent monitor may automatically disengage the bot in conversation with the user and automatically engage a human support agent in the conversation with the user. In this manner, user frustrations may be reduced as any support operator engaging the user in conversation continually exhibits adaptive intelligence. Typically, users expect responses with adaptive intelligence to indicate an understanding of what is conveyed by the user.

The handoff may occur from a bot to a human support agent or vice versa. As illustrated in FIG. 4, a handoff occurs in the communication flow at reference number 442 from a bot-controlled conversation to a human support agent-controlled conversation. Similarly, at reference number 444, a handoff occurs in the communication flow from a human support agent-controlled conversation to a bot-controlled conversation. As illustrated in FIG. 4, the handoff 442 is a temporary handoff. In an example where the bot and human support agent alternate control of turns of conversation, the handoff may a partial handoff, where the human support agent engages in a turn of conversation to supplement bot response generation. In embodiments, any number of turns of communication may be executed. Moreover, any number of handoffs between a bot and human support agent may occur. In embodiments, a human support agent may use particular words or phrases that signal a bot to reengage control of the conversation. For example, in response to the completion of a particular task by the human support agent, the agent may with “I am glad we solved that issue. Is there anything else I can do for you?” In response to this phrase, the bot logic as described herein may resume control of the conversation. Thus, a signal to the bot to reengage in conversation with the user may be particular words or phrases used by the human support agent in the conversation.

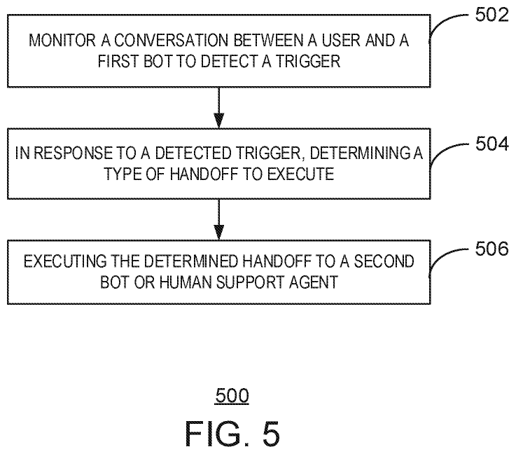

FIG. 5 is an illustration of a process flow diagram of a method 500 that enables a handoff between a bot and human. At block 502, a conversation between a user and a first bot is monitored to detect a trigger. As described above, the trigger is detected by assessing one or more factors associated with the user, wherein assessing the one or more factors comprises a determination that a user frustration level exceeds a predetermined threshold.

At block 504, in response to a detected trigger, a type of a handoff to be executed is determined. The handoff is to a second bot or a human support agent and the type of handoff is based on an experience of a user. As used herein, the experience of the user may refer to user attributes and historic user information obtained from previous conversations with the user. In embodiments, the type of handoff may be partial or temporary. Moreover, the handoff may be from the first bot to a second bot, wherein the second bot has functionality that can address information detected in the user input that is not available at the first bot. At block 506, the determined handoff to the second bot or a human support agent may be executed, wherein the second bot or a human support agent engages the user in conversation to execute functionality desired by the user.

In this manner, the present techniques incorporate multiple attributes into a model that predicts when a handoff should occur. Further, the handoff may be the handoff is partial or temporary. For example, in a partial handoff, the human support agent is injected into the conversation and does not need take control of the conversation completely or indefinitely. The human support agent can supplement the information provided by the bot. For example, the human support agent can re-route the user elsewhere, provide a link or other information, or resolve an ambiguity. The human support agent may re-route the user to another bot. When the human support agent tasks are complete, control of the conversation may automatically return to the bot.

In one embodiment, the process flow diagram of FIG. 5 is intended to indicate that the steps of the method 500 are to be executed in a particular order. Alternatively, in other embodiments, the steps of the method 500 can be executed in any suitable order and any suitable number of the steps of the method 500 can be included. Further, any number of additional steps may be included within the method 500, depending on the specific application.

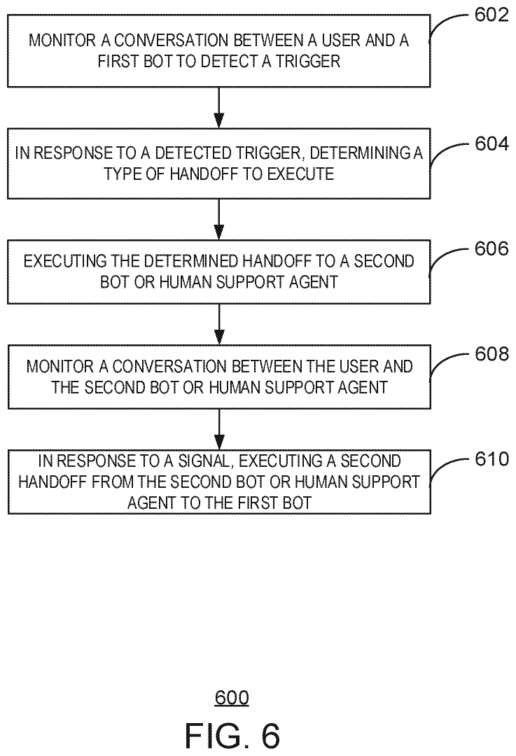

FIG. 6 is an illustration of a process flow diagram of a method 600 that enables two-way handoff between a bot and human. At block 602, a conversation between a user and a first bot is monitored to detect a trigger. As described above, the trigger is detected by assessing one or more factors associated with the user, wherein assessing the one or more factors comprises a determination that a user frustration level exceeds a predetermined threshold.

At block 604, in response to a detected trigger, a type of a handoff to be executed is determined. In embodiments, the type of handoff may be partial or temporary. For example, a human support agent may engage in a partial handoff, where the human support agent supplements responses generated by the bot. The handoff may be temporary, where the human support agent may temporarily take complete control of the conversation. At block 606, the determined handoff to the second bot or a human support agent may be executed, wherein the second bot or a human support agent engages the user in conversation to execute functionality desired by the user.

At block 608, a conversation between the user and the second bot or human support agent is monitored to detect a signal to reengage the first bot in the conversation. In embodiments, the first bot monitors the conversation between the user and the second bot or human support agent to detect a signal to reengage in conversation with the user. The signal for the first bot to reengage in conversation with the user may be a determination that the functionality desired by the user is complete. At block 610, in response to a detected signal, a second handoff from the second bot or human support agent to the first bot is executed. In this manner, the present techniques enable a two-way handoff from a bot to a second bot or human support agent, and from the second bot or human support agent to the first bot. Through the two-way handoff, the first bot may automatically reengage in conversation with the user, or the second bot/human support agent can deliberately transfer control back to the first bot at an appropriate juncture. The present techniques enable a single human support agent can scale human provided support more effectively across a larger number of user-bot interactions.

In one embodiment, the process flow diagram of FIG. 6 is intended to indicate that the steps of the method 600 are to be executed in a particular order. Alternatively, in other embodiments, the steps of the method 600 can be executed in any suitable order and any suitable number of the steps of the method 600 can be included. Further, any number of additional steps may be included within the method 600, depending on the specific application.

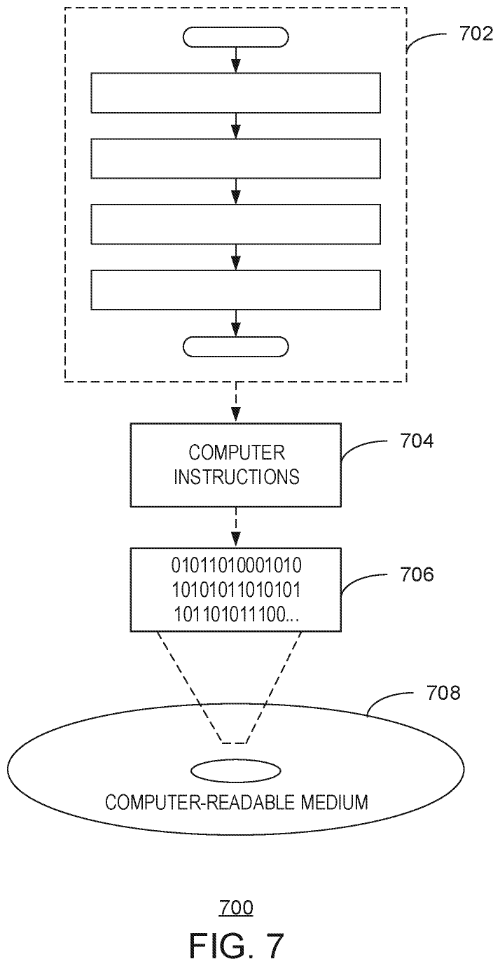

Turning to FIG. 7, FIG. 7 is a block diagram illustrating an exemplary computer readable medium encoded with instructions to enable a handoff between a bot and human according to aspects of the disclosed subject matter. More particularly, the implementation 700 comprises a computer-readable medium 708 (e.g., a CD-R, DVD-R or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 500 of FIG. 5, for example. In another such embodiment, the processor-executable instructions 704 may be configured to implement a system, such as at least some of the exemplary system 800 of FIG. 8, as described below. Many such computer-readable media may be devised by those of ordinary skill in the art that are configured to operate in accordance with the techniques presented herein.

Turning to FIG. 8, FIG. 8 is a block diagram illustrating an exemplary computing device 800 configured to enable a handoff between a bot and human according to aspects of the disclosed subject matter. The exemplary computing device 800 includes one or more processors (or processing units), such as processor 802, and a memory 804. The processor 802 and memory 804, as well as other components, are interconnected by way of a system bus 810. The memory 804 typically (but not always) comprises both volatile memory 806 and non-volatile memory 808. Volatile memory 806 retains or stores information so long as the memory is supplied with power. By contrast, non-volatile memory 808 is capable of storing (or persisting) information even when a power supply is not available. Generally speaking, RAM and CPU cache memory are examples of volatile memory 806 whereas ROM, solid-state memory devices, memory storage devices, and/or memory cards are examples of non-volatile memory 808.

The processor 802 executes instructions retrieved from the memory 804 (and/or from computer-readable media, such as computer-readable medium 808 of FIG. 8) in carrying out various functions of a handoff between a bot and human as described above. The processor 802 may be comprised of any of a number of available processors such as single-processor, multi-processor, single-core units, and multi-core units.

Further still, the illustrated computing device 800 includes a network communication component 812 for interconnecting this computing device with other devices and/or services over a computer network, including other user devices, such as user computing devices 114, 118, and 122 as illustrated in FIG. 1. The network communication component 812 may also this computing device with other human support agent devices 110 and 126 as illustrated in FIG. 1. The network communication component 812, sometimes referred to as a network interface card or NIC, communicates over a network (such as network illustrated in FIG. 1) using one or more communication protocols via a physical/tangible (e.g., wired, optical, etc.) connection, a wireless connection, or both. As will be readily appreciated by those skilled in the art, a network communication component, such as network communication component 812, is typically comprised of hardware and/or firmware components (and may also include or comprise executable software components) that transmit and receive digital and/or analog signals over a transmission medium (i.e., the network.)

The computing device 800 also includes a bot 814. The bot 814 may include a plurality of independent executable modules that are configured (in execution) as follows. In operation/execution, a language processing module 818 may process input from a user is processed to derive a request, query, or other information from the user input. In embodiments, the natural language processing may be used by the machine learning module to extract entities and intents from the user input. The machine learning module 820 may learn from the entities and intents extracted from the user input via natural language processing. The machine learning algorithms according to the present techniques may be based on a classification algorithm that includes decision tree. The decision tree may include a series of observations that are used to arrive at a conclusion. Various entities and intents may be mapped to elements of the decision tree. The intent monitor module 822 may monitor a conversation between a user and a first bot to detect a trigger, wherein the trigger is detected by assessing one or more factors associated with the user, wherein assessing the one or more factors comprises a determination that a user frustration level exceeds a predetermined threshold. The bot may access a knowledge base 816 as needed. Elements of the decision tree may be used by the response generation module 824 to determine a pre-written response to the original user input. The response generation module may transmit the pre-written response to a dialogue client where it is rendered for the user in a text, auditory, or visual format.

### EXAMPLES

Example 1 is a method. The method includes monitoring a conversation between a user and a first bot to detect a trigger, wherein the trigger is detected by assessing one or more factors associated with the user, wherein assessing the one or more factors comprises a determination that a user frustration level exceeds a predetermined threshold; in response to a detected trigger, determining a type of a handoff to be executed, wherein the handoff is to a second bot or a human support agent, and the type of handoff is based on an experience of the user; and executing the determined handoff to the second bot or the human support agent, wherein the second bot or the human support agent engages the user in conversation to execute functionality desired by the user.

Example 2 includes the method of example 1, including or excluding optional features. In this example, the type of handoff is a temporary handoff to a human support agent and the human support agent provides a signal to the first bot to reengage in the conversation with the user via a second handoff.

Example 3 includes the method of any one of examples 1 to 2, including or excluding optional features. In this example, the type of handoff is a partial handoff to a human support agent, wherein the human support agent supplements responses to the user as generated by the first bot.

Example 4 includes the method of any one of examples 1 to 3, including or excluding optional features. In this example, the type of handoff is a temporary handoff to a human support agent, wherein the human support agent generates responses to the user, and the first bot automatically reengages the conversation in response to a resolution of an issue detected in the conversation.

Example 5 includes the method of any one of examples 1 to 4, including or excluding optional features. In this example, the type of handoff is a full handoff to a second bot, wherein the second bot is better suited for the conversation based on the user input.

Example 6 includes the method of any one of examples 1 to 5, including or excluding optional features. In this example, the determination that a user frustration level exceeds a predetermined threshold is made by scoring one or more factors as detected in the user input and comparing the total score with the predetermined threshold.

Example 7 includes the method of any one of examples 1 to 6, including or excluding optional features. In this example, the type of handoff is a temporary handoff to a human support agent, wherein the human support agent generates responses to the user and then transfers the conversation to a second bot in response to a determination that the second bot is better suited to resolve a user request.

Example 8 includes the method of any one of examples 1 to 7, including or excluding optional features. In this example, the one or more factors comprises a sentiment analysis, a text format, trigger words, user intent, user attributes, or any combination thereof.

Example 9 includes the method of any one of examples 1 to 8, including or excluding optional features. In this example, the experience of the user is historic data associated with the user, users similar to the user, or all users.

Example 10 includes the method of any one of examples 1 to 9, including or excluding optional features. In this example, the one or more factors is used to build a model that indicates when a handoff should occur and the type of handoff that should occur.

Example 11 is a system. The system includes an intent monitor to monitor a conversation between a user and a first bot to detect a trigger, wherein the trigger is detected by assessing one or more factors associated with the user, wherein assessing the one or more factors comprises a determination that a user frustration level exceeds a predetermined threshold; in response to a detected trigger, the intent monitor to determine a type of a handoff to be executed, wherein the handoff is to a second bot or a human support agent and the type of handoff is based on an experience of a user; and the intent monitor to execute the determined handoff to the second bot or a human support agent by the intent monitor, wherein the second bot or a human support agent engages the user in conversation to execute functionality desired by the user.

Example 12 includes the system of example 11, including or excluding optional features. In this example, the type of handoff is a temporary handoff to a human support agent and the human support agent provides a signal to the first bot to reengage in the conversation with the user via a second handoff.

Example 13 includes the system of any one of examples 11 to 12, including or excluding optional features. In this example, the type of handoff is a partial handoff to a human support agent, wherein the human support agent supplements responses to the user as generated by the first bot.

Example 14 includes the system of any one of examples 11 to 13, including or excluding optional features. In this example, the type of handoff is a temporary handoff to a human support agent, wherein the human support agent generates responses to the user and the first bot automatically reengages the conversation in response to a resolution of an issue detected in the conversation.

Example 15 includes the system of any one of examples 11 to 14, including or excluding optional features. In this example, the type of handoff is a full handoff to a second bot, wherein the second bot is better suited for the conversation based on the user input.

Example 16 includes the system of any one of examples 11 to 15, including or excluding optional features. In this example, the determination that a user frustration level exceeds a predetermined threshold is made by scoring one or more factors as detected in the user input and comparing the total score with the predetermined threshold.

Example 17 includes the system of any one of examples 11 to 16, including or excluding optional features. In this example, the type of handoff is a temporary handoff to a human support agent, wherein the human support agent generates responses to the user and then transfers the conversation to a second bot in response to a determination that the second bot is better suited to resolve a user request.

Example 18 is a method. The method includes monitoring a conversation between a user and a bot to detect a trigger, wherein the trigger is detected by assessing one or more factors associated with the user, wherein assessing the one or more factors comprises a determination that a user frustration level exceeds a predetermined threshold; in response to a detected trigger, determining a type of a first handoff to be executed, wherein the first handoff is from the bot to a human support agent, and the type of the first handoff is based on an experience of the user; executing the determined first handoff from the bot to the human support agent, wherein the human support agent engages the user in conversation to execute functionality desired by the user; monitoring a conversation between the user and the human support agent to detect a signal, wherein the signal is an indication that the functionality desired by the user is complete; in response to the detected signal, executing a second handoff from the human support agent to the bot.

Example 19 includes the method of example 18, including or excluding optional features. In this example, the detected signal is generated when the human support agent reduces the user frustration level.

Example 20 includes the method of any one of examples 18 to 19, including or excluding optional features. In this example, the detected signal is generated from particular words or phrases used by the human support agent in the conversation.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method, comprising:
monitoring a conversation between a user and a first bot to detect a trigger, wherein the trigger is detected by assessing one or more factors associated with the user, wherein assessing the one or more factors comprises a determination that a user frustration level exceeds a predetermined threshold;
in response to a detected trigger, determining a type of a handoff to be executed, wherein the handoff is to a second bot or a human support agent, and the type of handoff is based on an experience of the user; and
executing the determined handoff to the second bot or the human support agent, wherein the second bot or the human support agent engages the user in conversation to execute functionality desired by the user.

2. The method of claim 1, wherein the type of handoff is a temporary handoff to a human support agent and the human support agent provides a signal to the first bot to reengage in the conversation with the user via a second handoff.

3. The method of claim 1, wherein the type of handoff is a partial handoff to a human support agent, wherein the human support agent supplements responses to the user as generated by the first bot.

4. The method of claim 1, wherein the type of handoff is a temporary handoff to a human support agent, wherein the human support agent generates responses to the user, and the first bot automatically reengages the conversation in response to a resolution of an issue detected in the conversation.

5. The method of claim 1, wherein the type of handoff is a full handoff to a second bot, wherein the second bot is better suited for the conversation based on the user input.

6. The method of claim 1, wherein the determination that a user frustration level exceeds a predetermined threshold is made by scoring one or more factors as detected in the user input and comparing the total score with the predetermined threshold.

7. The method of claim 1, wherein the type of handoff is a temporary handoff to a human support agent, wherein the human support agent generates responses to the user and then transfers the conversation to a second bot in response to a determination that the second bot is better suited to resolve a user request.

8. The method of claim 1, wherein the one or more factors comprises a sentiment analysis, a text format, trigger words, user intent, user attributes, or any combination thereof.

9. The method of claim 1, wherein the experience of the user is historic data associated with the user, users similar to the user, or all users.

10. The method of claim 1, wherein the one or more factors is used to build a model that indicates when a handoff should occur and the type of handoff that should occur.

11. A system, comprising:
an intent monitor to monitor a conversation between a user and a first bot to detect a trigger, wherein the trigger is detected by assessing one or more factors associated with the user, wherein assessing the one or more factors comprises a determination that a user frustration level exceeds a predetermined threshold;
in response to a detected trigger, the intent monitor to determine a type of a handoff to be executed, wherein the handoff is to a second bot or a human support agent and the type of handoff is based on an experience of the user; and
the intent monitor to execute the determined handoff to the second bot or the human support agent by the intent monitor, wherein the second bot or the human support agent engages the user in conversation to execute functionality desired by the user.

12. The system of claim 11, wherein the type of handoff is a temporary handoff to a human support agent and the human support agent provides a signal to the first bot to reengage in the conversation with the user via a second handoff.

13. The system of claim 11, wherein the type of handoff is a partial handoff to a human support agent, wherein the human support agent supplements responses to the user as generated by the first bot.

14. The system of claim 11, wherein the type of handoff is a temporary handoff to a human support agent, wherein the human support agent generates responses to the user and the first bot automatically reengages the conversation in response to a resolution of an issue detected in the conversation.

15. The system of claim 11, wherein the type of handoff is a full handoff to a second bot, wherein the second bot is better suited for the conversation based on the user input.

16. The system of claim 11, wherein the determination that the user frustration level exceeds a predetermined threshold is made by scoring one or more factors as detected in the user input and comparing a total score with the predetermined threshold.

17. The system of claim 11, wherein the type of handoff is a temporary handoff to a human support agent, wherein the human support agent generates responses to the user and then transfers the conversation to a second bot in response to a determination that the second bot is better suited to resolve a user request.

18. A method, comprising:
monitoring a conversation between a user and a bot to detect a trigger, wherein the trigger is detected by assessing one or more factors associated with the user, wherein assessing the one or more factors comprises a determination that a user frustration level exceeds a predetermined threshold;
in response to a detected trigger, determining a type of a first handoff to be executed, wherein the first handoff is from the bot to a human support agent, and the type of the first handoff is based on an experience of the user;
executing the determined first handoff from the bot to the human support agent, wherein the human support agent engages the user in conversation to execute functionality desired by the user;
monitoring a conversation between the user and the human support agent to detect a signal, wherein the signal is an indication that the functionality desired by the user is complete;
in response to the detected signal, executing a second handoff from the human support agent to the bot.

19. The method of claim 18, wherein the detected signal is generated when the human support agent reduces the user frustration level.

20. The method of claim 18, wherein the detected signal is generated from particular words or phrases used by the human support agent in the conversation.
